(19) United States
(12) Patent Application Publication
(10) Pub. No.: US 2026/0061428 A1
(43) Pub. Date: Mar. 5, 2026

(54) Crushing device for comminuting mineral material

(71) Applicant: Kleemann GmbH, Göppingen (DE)

(72) Inventors: Sebastian Grot, Holzmaden (DE); Steffen Häberle, Herbrechtingen (DE); Till Krauss, Rechberghausen (DE); Jochen Meier, Hülben (DE)

(21) Appl. No.: 19/289,194

(22) Filed: Aug. 4, 2025

(30) Foreign Application Priority Data
Sep. 4, 2024 (DE) 10 2024 125 359.2

(51) Int. Cl. B02C 25/00; B02C 13/28; B02C 21/02

(52) U.S. Cl. CPC B02C 25/00; B02C 13/2804; B02C 21/026; B02C 2210/01

(57) ABSTRACT

A crushing device for crushing mineral material includes at least one crushing chamber boundary delimiting a crushing chamber, the at least one crushing chamber boundary including an inner face facing the crushing chamber and an outer face facing away from the crushing chamber. The crushing chamber boundary includes an inspection opening. A comminution device is received in the crushing chamber, the comminution device including at least one comminution tool. A sensor is configured to determine a state of wear of at least one wear part in the crushing chamber. A mounting is configured to hold the sensor. An actuator is configured to move the sensor at least partially through the inspection opening between a park position wherein the sensor is at least partially outside of the crushing chamber and a detection position wherein the sensor is at least partially inside of the crushing chamber.

### RELATED APPLICATIONS

The present application claims priority to German Patent Appl. Ser. No. DE 10 2024 125 359.2 filed Sep. 4, 2024, which is incorporated herein by reference.

### BACKGROUND OF THE DISCLOSURE

### Field of the Disclosure

The disclosure relates to a crushing device for crushing mineral material or the like, having a crusher unit, which has a crushing chamber, wherein a comminution device is accommodated in the crushing chamber, in particular movably, preferably rotatably or in a swiveling manner, wherein the comminution device bears or has at least one comminution tool, in particular a crushing tool, wherein the crushing chamber is delimited by at least one crushing chamber boundary, wherein the crushing chamber boundary has an inner face facing the crushing chamber and an outer face facing away from the crushing chamber, and wherein the crushing chamber boundary has an inspection opening.

Crushing devices according to the disclosure can, for instance, be designed such that they have a rotor as the comminution device, which rotor is held rotatably in the crushing chamber. Such a crushing device can therefore be an impact crusher, a cone crusher or a gyratory crusher. Alternatively, it can also be a comminution device, in which the comminution device has a crushing body disposed in the crushing chamber in a swiveling manner. Such crushing devices can be jaw crushers, for instance.

The crushing tool can be an exchangeable tool that is interchangeably connected to the comminution tool, for instance. In particular, the crushing tool can be an impact bar, an impact rocker, a crusher spindle, a crusher roll or a crushing jaw.

In the context of the disclosure, the crushing tool does not necessarily have to be part of the movable part (for instance, the rotor or the swiveling crushing body) of the comminution tool. Rather, in the context of the disclosure, the crushing tool can be a part that is disposed in the crushing chamber at least sectionally, for instance an impact rocker or a crushing chamber lining, in particular also a part of the crushing chamber boundary.

### Description of the Prior Art

The crushing chamber of generic crushing devices, in particular rock comminution machines, is very difficult to access due to the nature of the system. The safety measures required to access the crushing chamber render accessibility even more difficult. Regularly checks of the wear parts in the crushing chamber is therefore very time-consuming. To this end, sensor-based wear measurements offer an enormous advantage, both in terms of operator safety and machine downtime. In addition to a pure wear measurement, which enables the operator to plan the adjustment of the crushing gap as wear progresses and the stockpiling of wear parts and their installation, such a system can detect damage in good time and prevent major machine damage. In addition, sensor-based wear measurements offer significant advantages in terms of measurement accuracy compared to the visual evaluation by the machine operator that is common today.

Solutions are known from the state of the art, in which wear parts of a comminution tool consist of a cast material. The measuring system of the detection device is built directly into the cast part. In cast parts, this can only be achieved at great expense. When the wear part is replaced, the detection device is also replaced, which requires a large number of parts.

Methods that use ultrasound to determine the layer thickness of wear parts are also known (see DE 2357432 B2 (US 3944146)). Ultrasonic sensors that are used to determine coating thickness usually use a sensor head that is attached directly to the wear part. The sound waves would otherwise be reflected or refracted when the medium changes (e.g. air to steel). Such a sensor arrangement is also impractical.

### SUMMARY OF THE DISCLOSURE

The disclosure addresses the problem of providing a crushing device of the type mentioned at the beginning, which renders a safe and reliable wear detection possible.

This problem is solved in that a detection device, held by a mounting, for determining the wear condition of at least one wear part, in particular the wear part, in particular the comminution tool, is provided, in that the detection device can be moved between a park position and a detection position through the inspection opening by means of an actuator, wherein the detection device is arranged in the detection position at least sectionally inside the crushing chamber and is arranged outside of the crushing chamber in the park position.

The detection device is therefore no longer assigned to the wear part but can be used separately therefrom. In the operating position, the detection device is available inside the crushing chamber and can detect the condition of the wear part. Once the condition of the wear part has been detected, the actuator moves the detection device through the inspection opening into the protected area behind the outer face of the crushing chamber boundary. Preferably, the crushing device can be stopped for a short time to determine the wear of the wear part and then the detection device can be moved into the crushing chamber. This permits the wear part condition to be detected effectively and safely. The risk of damage to the detection device due to the effects of crushed material and/or dust is virtually eliminated.

In particular, the detection device may be an optical measuring device, for instance a measuring device having a laser scanner or a camera, preferably a stereo camera (in particular a 3D camera) or a 2D camera. It is also conceivable that the detection device has one or more laser distance sensors or ToF cameras. Electromagnetic distance measurement methods such as radar sensors or eddy current sensors or capacitive measurement methods are also conceivable. The detection device may also be referred to as a sensor configured to determine the wear state of at least one wear part in the crushing chamber.

According to the disclosure, the wear part may in particular be the comminution device or a part of the comminution device. It is conceivable that the wear part according to the disclosure is a comminution tool or a part of the comminution tool, for instance the crushing tool. It is also conceivable that the wear part according to the disclosure is the crushing chamber lining or a part of the crushing chamber lining. In the context of the disclosure, a wear part can also be any other component that comes into contact with the material to be crushed or comminuted in the crushing chamber.

According to a preferred variant of the disclosure, provision may be made for the actuator to be held at least in the park position outside of the crushing chamber in the area of the outer face. This means that the actuator is also protected on the outer face of the crushing chamber boundary during the crushing operation.

A conceivable variant of the disclosure can be such that the mounting can be moved between the park position and the detection position by means of an adjusting device comprising the actuator, and that the detection device is moved translationally at least sectionally by means of the adjusting device or is moved at least sectionally along an arcuate path, in particular a circular path. Depending on the geometric conditions, the suitable motion variant can be used. This permits a space-saving design to be implemented and the detection device to be positioned exactly in the detection position in the crushing chamber.

According to a conceivable variant of the disclosure, provision may be made for the adjusting device to comprise a transmission, which is driven by the actuator. In this way, a motion ratio to be achieved such that, for instance, a sufficiently large adjustment path of the detection device can be implemented with a relatively small adjustment travel of the actuator. In this way, a compact, space-saving design can be implemented.

If the detection device is moved on an arcuate path by means of the adjusting device, advantageously provision is made for the mounting to be swiveled by more than 60° between the park position and the detection position. In this way, a sufficiently large detection area is available for the detection device in the detection position.

If provision is made for the mounting to form a housing, in which the detection device is accommodated and for the housing to have a light-transmission area, in particular an opening, which, in the detection position, establishes a straight line of sight between the detection device and the at least one wear part, in particular the crushing tool, then the detection device is protected from mechanical impact in the housing. The opening of the housing ensures that the wear condition can be reliably detected in the detection position. Preferably, in the detection position, the opening of the housing is directed downwards in the direction of gravity. This at least reduces the risk of rock particles falling inside the crushing chamber onto the detection equipment. Provision may additionally or alternatively be made for the opening to be at least sectionally covered by a cover that is permeable to the measurement signal.

A particularly preferred variant of the disclosure is such that a sealing arrangement is provided, which, in the park position and/or in the detection position, closes the inspection opening in a dust-tight manner at least sectionally. This prevents or at least significantly reduces the risk of dust from the crushing chamber reaching the area of the outer face of the crushing chamber boundary in the respective positions.

A particularly effective sealing closure can be achieved if provision is made for the mounting to have sealing sections as part of the sealing arrangement, which sealing sections, in the park position, face edge sections of the inspection opening in a sealing manner and/or for the mounting to have a limiting element, which, in the detection position, faces edge sections of the inspection opening in a sealing manner.

A particularly simple design is achieved if provision is made for a sealing section to be provided on the mounting, which faces edge sections of the inspection opening in a sealing manner both in the park position and in the detection position.

Further preferably, provision may be made for the sealing section of the mounting to be guided past the edge section of the inspection opening in a sealing manner during the movement between the detection position and the park position, such that a dust-tight seal is also ensured at least in sections during the adjustment movement.

A variant of the disclosure can be such that sealing sections of the mounting are arranged on opposite ends of the mounting and extend in the direction of the swivel axis, about which the mounting is swivel mounted, that the sealing sections preferably have an outer contour, each of which follows the shape of a partial cylinder, and whose cylinder axis extends in parallel to the axis of rotation of the mounting, and/or that the edge sections of the inspection opening preferably each have an outer contour, each of which follows the shape of a partial cylinder, whose cylinder axis extends in parallel to the axis of rotation of the mounting. This results in a sealing closure on the opposite ends of the beam, which is simple in design. If provision is made for the cylinder axis/axes and the swivel axis of the mounting to be aligned with each other, the mounting can be moved on a circular path, wherein a sealing closure is ensured on the opposite ends of the mounting during this adjustment movement.

A crushing device according to the disclosure can be such that the actuator has a linear damper having a cylinder and a piston guided therein, wherein the piston is coupled to a piston rod, and that the actuator is coupled directly or indirectly to the detection device by means of an adjusting piece in a swiveling manner. This results in a simple design. The linear damper can preferably be designed as a hydraulic cylinder connected to the hydraulic system of the crushing device. Preferably, the adjusting piece is used to directly couple the cylinder or the piston rod to the mounting.

However, it is also conceivable that a deflection mechanism, for instance a deflection lever or a deflection gear, is provided, which is arranged in the area between the actuator and the mounting to ensure a suitable motion of the mounting.

For a space-saving design, provision may be made for a holding device to be arranged in the area of the outer face of the crushing chamber boundary, in particular to be attached to the crushing chamber boundary, for the holding device to have a spacer, which holds a bearing attachment of the actuator spaced apart from the outer face, and for the actuator to be coupled to the holding device by means of the bearing attachment in a swiveling manner.

If provision is made for the mounting in the park position to be covered by a cover section of a cover, wherein the cover section is held at a distance from the outer face of the crushing chamber boundary, then the detection device is also protected from external influences in the park position, in particular mechanical influences or from dust exposure.

The cover may be opened for maintenance purposes to gain access to the detection device. Preferably, when the cover is open, the fastening means, by which the detection device is held to the mounting, can be released such that the detection device can be easily removed for maintenance. This means that the detection unit can be removed without dismantling the mounting. In addition, when the cover is open, the detection device can also be easily cleaned if necessary.

A variant of the disclosure may provide that, in the park position, the detection device is accommodated in a mount space, preferably in a mount space of the mounting, which is accessible through an opening in the park position, and that a seal is arranged between the cover and the mount space, preferably at least sectionally, around the opening, to seal the mount space at least sectionally. This reduces or eliminates the risk of the detection device becoming dirty in the park position. The opening can preferably be the same opening through which the detection device also detects the wear condition of the wear part, in particular the crushing tool, in the detection position.

A particularly preferred variant of the disclosure is such that in the park position the inspection opening of the crushing chamber boundary is closed by a closing arrangement, wherein in its closed position the closing arrangement is arranged between the crushing chamber and the detection device. The closing arrangement prevents broken pieces of material from entering the area of the outer face of the crushing chamber boundary during the crushing operation. In this way, the crushing chamber boundary protects the detection device and seals it off from the crushing chamber.

Advantageously, to protect the detection device, provision is made for the surface of the closing arrangement facing the crushing chamber to have the same or a higher wear resistance than the crushing chamber boundary.

Advantageously, in the detection position provision may also be made for a return spring having a pretensioning force, which acts in the direction of the park position, to act directly or indirectly on the detection device to generate or support an adjustment movement of the detection device in the direction of the park position. As a result, the detection device, in particular the mounting, is held in the park position or brought into the park position when the actuator is deactivated. This increases operational safety.

According to one variant of the disclosure, it is also conceivable that the mounting has a contour area, which is guided past a scraper during a movement between the detection position and the park position. This removes any impurities adhering to the mounting when the mounting is moved.

### BRIEF DESCRIPTION OF THE DRAWINGS:

The disclosure is explained in greater detail below based on exemplary embodiments shown in the drawings. In the figures,

FIG. 1 shows a schematic representation and side view of a material processing plant having a crusher unit,

FIG. 2 shows a perspective view from the left of a schematic representation of a part of the crusher unit of the material processing plant of FIG. 1,

FIG. 3 shows a perspective view of the structural unit of FIG. 2 from the right,

FIG. 4 shows a perspective view of a detection device of the mineral processing plant of FIGS. 1-3,

FIGS. 5 and 6 show two different operating views of the detection device of FIG. 4 and in side view,

FIG. 7 shows side view of a modified variant of the detection device of FIGS. 4-6 and in a park position

FIG. 8 shows the detection device of FIG. 7 in a detection position,

FIG. 9 shows a perspective view of an alternative design variant of a detection device,

FIG. 10 shows a side view and sectional view of the detection device of FIG. 9, and

FIG. 11 shows the detection device of FIG. 10 in a modified operating position, namely in a park position.

### DETAILED DESCRIPTION:

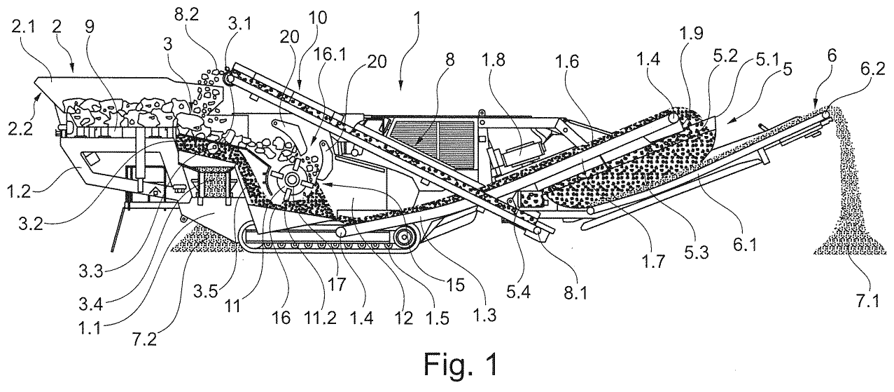

FIG. 1 shows a material processing plant 1 in the form of a crusher having a material processing unit in the form of a crusher unit 10. The material processing plant 1 is designed as a mobile material processing plant 1 and therefore has travel units 1.5. However, it is also conceivable that the material processing plant 1 is a stationary material processing plant 1.

The material processing plant 1 has a chassis 1.1 that bears the machine components or at least a part of the machine components. At its rear end, the chassis 1.1 can preferably have a cantilever 1.2. A material feed area is formed in the area of the cantilever 1.2.

The material feed area may comprise a feed hopper 2 and a material feed device 9.

The feed hopper 2 may be formed at least in part by hopper walls 2.1 extending in the direction of the longitudinal extent of the material processing plant 1 and a rear wall 2.2 extending transversely to the longitudinal extent. The feed hopper 2 leads to the material feed device 9.

As shown in this exemplary embodiment, the material feed device 9 comprise have a conveyor chute that can be driven by means of a vibratory drive. The feed hopper 2 can be used to feed material to be comminuted into the material processing plant 1, for instance using a wheel loader, and to feed it onto the conveyor chute.

As the drawing shows, it may preferable for the material to be comminuted to pass from the conveyor chute into the area of a screen unit 3. This screen unit 3 may also be referred to as a pre-screening arrangement. At least one screen deck 3.1, 3.2 is disposed in the area of the screen unit 3. In this exemplary embodiment two screen decks 3.1, 3.2 are used. A system configuration in which no pre-screen arrangement is used is also conceivable.

A partial fraction of the material to be comminuted is screened out at the upper screen deck 3.1. This partial fraction already has a sufficient particle size that it no longer needs to be comminuted in the material processing plant 1. In this respect, this screened out partial fraction can be routed past the crusher unit 10 through a bypass channel 3.5.

If a second screen deck 3.2 is used in the screen unit 3, a further fine particle fraction can be screened out from the partial fraction that accumulates below the screen deck 3.1. This fine particle fraction can be routed to a lateral discharge conveyor 3.4 below the screen deck 3.2. The fine particle fraction is diverted from the lateral discharge conveyor 3.4 and conveyed to a rock pile 7.2 located laterally of the machine.

As FIG. 1 illustrates, the screen unit 3 may be a vibrating screen having a screen drive 3.3. The screen drive 3.3 causes the screen deck 3.1 and/or the screen deck 3.2 to vibrate. Owing to the inclined arrangement of the screen decks 3.1, 3.2 and in conjunction with the vibration motions, material on the screen decks 3.1, 3.2 is transported towards the crusher unit 10 or towards the bypass channel 3.5.

The material to be comminuted and arriving from the screen deck 3.1 is routed to the crusher unit 10, as shown in FIG. 1.

The crusher unit 10 can, for instance, take the form of an impact crusher unit, in particular a rotary impact crusher unit, a jaw crusher unit, a cone crusher unit or a gyratory crusher unit. The crusher unit 10 has a comminution device 11.

If a rotary impact crusher unit is used, as in FIG. 1, it has as comminution device 11, for instance, an impact rotor, which is driven by an internal combustion engine 12. In FIG. 1, the axis of rotation 17 of the impact rotor is horizontal in the direction of the image depth. The impact rotor is housed in a crushing chamber 16.1.

If a jaw crushing unit is used, the comminution device 11 has two opposing crushing jaws that enclose a converging crushing shaft between them, resulting in a crushing gap. At least one of the crushing jaws may be driven, for instance by the internal combustion engine 12, to crush the material to be crushed filled in the converging crushing gap.

For instance, the outer circumference of the impact rotor can be fitted with comminution tools 11.2, which are designed as impact bars in this case. Opposite from the impact rotor, for instance, wall elements may be disposed, preferably in the form of impact rockers 20. When the impact rotor is rotating, the impact bars throw the material to be comminuted outwards. In so doing, this material hits the impact rockers 20 and is comminuted due to the high kinetic energy. When the material to be comminuted is of sufficient particle size to allow the material particles to pass through a crushing gap 15 between the impact rockers 20 and the radially outer ends of the impact bars, the comminuted material exits the crusher unit 10 through the crusher outlet 16.

It is conceivable that in the area of the crusher outlet 16, the comminuted material routed from the crusher unit 10 is combined with the material routed from the bypass channel 3.5 and transferred onto a belt conveyor 1.3. The belt conveyor 1.3 can be used to convey the material out of the working area of the crusher unit 10.

As shown in the drawings, the belt conveyor 1.3 may comprise an endless circulating conveyor belt having a slack side 1.6 and a tight side 1.7. The slack side 1.6 is used to catch and transport away the crushed material falling from the crusher outlet 16 of the crusher unit 10. At the belt ends, deflection rollers 1.4 can be used to deflect the conveyor belt from the slack side 1.6 to the tight side 1.7 and vice versa. Guides, in particular support rollers, can be provided in the area between the deflection rollers 1.4 to change the direction of conveyance of the conveyor belt, to shape the conveyor belt in a certain way and/or to support the conveyor belt.

The belt conveyor 1.3 has a belt drive, which can be used to drive the belt conveyor 1.3. The belt drive can preferably be disposed at the discharge end 1.9 or in the area of the discharge end 1.9 of the belt conveyor 1.3.

The belt conveyor 1.3 can be connected, for instance by means of the belt drive, to a control device by means of a control line.

One or more further belt conveyors 6 and/or a return conveyor 8 may be used, which in principle have the same design as the belt conveyor 1.3. In this respect, reference can be made to the above statements.

A magnet 1.8, in particular an electric magnet, can be disposed in particular above the slack side 1.6 in the area between the feed end and the discharge end 1.9. The magnet 1.8 can be used to lift iron parts from the broken material and move them out of the conveying area of the belt conveyor 1.3.

A re-screening device 5 can be disposed downstream of the belt conveyor 1.3. The crusher unit 5 has a screen housing 5.1, in which at least one screen deck 5.2 is mounted. Below the screen deck 5.2, a housing base 5.3 is formed, which is used as a collection space for the material screened out at the screen deck 5.2.

An opening in the lower housing part 5.3 establishes a spatial connection to the further belt conveyor 6. Here, the further belt conveyor 6 forms its feed area 6.1, wherein the screened material in the feed area 6.1 is directed onto the slack side of the further belt conveyor 6. The further belt conveyor 6 conveys the screened material towards its discharge end 6.2. From there, the screened material is transferred to a rock pile 7.1.

The material not screened out at the screen deck 5.2 of the re-screening device 5 is conveyed from the screen deck 5.2 onto a branch belt 5.4. The branch belt 5.4 can also be designed as a belt conveyor, i.e., reference can be made to the explanations given above with respect to the belt conveyor 1.3. In FIG. 1, the transport direction of the branch belt 5.4 extends in the direction of the image depth.

At its discharge end, the branch belt 5.4 transfers the un-screened material, also referred to as oversize material, to a feed area 8.1 of the return conveyor 8. The return conveyor 8, which may be a belt conveyor, conveys the oversize material towards the feed hopper 2. At its discharge end 8.2, the return conveyor 8 transfers the oversize material into the material flow, in particular into the material feed area. The oversize material can therefore be returned to the crusher unit 10 and crushed to the desired particle size.

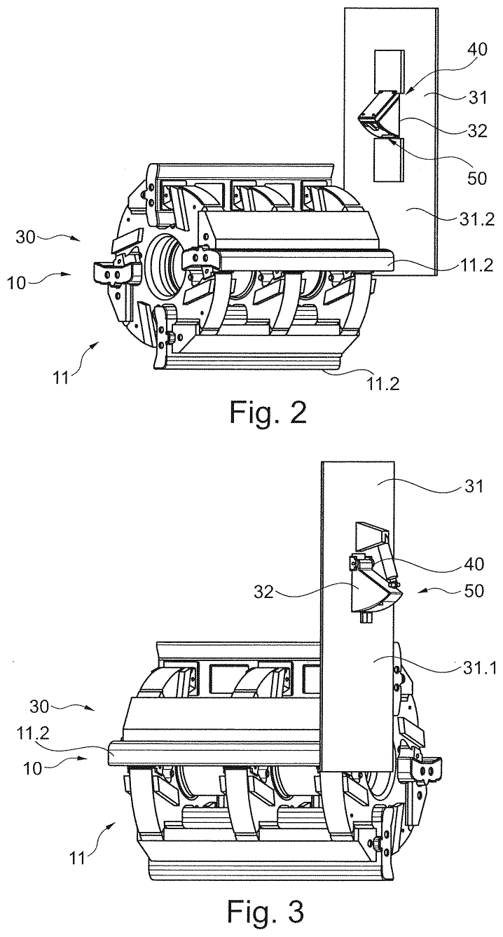

FIGS. 2 and 3 show the comminution devices 11 with their comminution tools 11.2. These are interchangeably held on the rotor of the comminution device 11. As the illustrations show, the comminution device 11 is disposed in the crushing chamber 30. The crushing chamber 30 is closed off from the surroundings, at least sectionally, by means of a crushing chamber boundary 31.

FIGS. 2 and 3 only show an example of a part of a crushing chamber boundary 31. As these figures illustrate, the crushing chamber boundary 31 can be a part of a wall, which has an inner face 31.2 facing the crushing chamber 30 and an outer face 31.1 facing away from the crushing chamber 30. The crushing chamber boundary 31 has an inspection opening 32. The inspection opening 32 can be formed by an aperture that is excluded or recessed from the crushing chamber boundary 31.

In this exemplary embodiment, the inspection opening 32 has the form of a rectangular aperture, which is delimited by opposing horizontal and opposing vertical edge sections.

As the illustrations show, a detection device 50 is disposed in the area of the crushing chamber boundary 31. FIG. 2 shows the detection device 50 in a detection position. In this detection position, the detection device 50 is arranged at least partially in the crushing chamber 30. The detection device 50 can then detect the state of wear of at least one of the comminution tools 11.2 or any other wear part in the crushing chamber 30.

FIG. 3 shows the detection device 50 in a park position. In this park position, the detection device 50 is moved out of the crushing chamber 30 and held in the area behind the outer face 31 of the crushing chamber boundary 31.

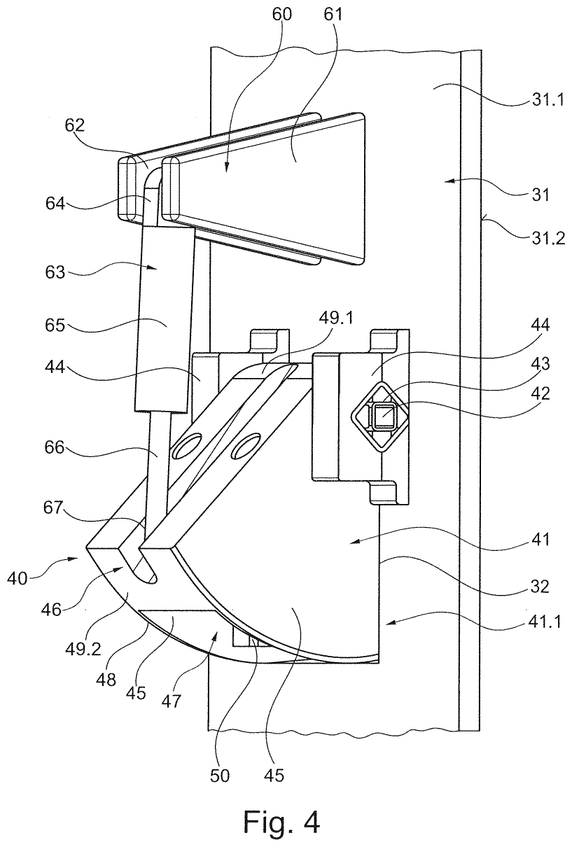

FIG. 4 shows the detection device 50 in an enlarged detailed view and in its park position. As the illustration shows, the detection device 50 is held on a mounting 40.

The mounting 40 can preferably have a housing 41 that forms a mount 47. The detection device 50 is accommodated in the mount 47 in a protected manner, at least sectionally.

The housing 41 may have lateral walls 45 delimiting the mount 47. The mount 47 has an opening 48, which is preferably formed as an aperture. The opening 48 can be covered by a cover that is permeable to the measurement signal of the detection device 50, for instance a transparent cover. Preferably, however, the opening 48 is designed as an aperture that is not covered.

For maintenance purposes, a user can access the detection device 50 through the opening 48, preferably in the park position.

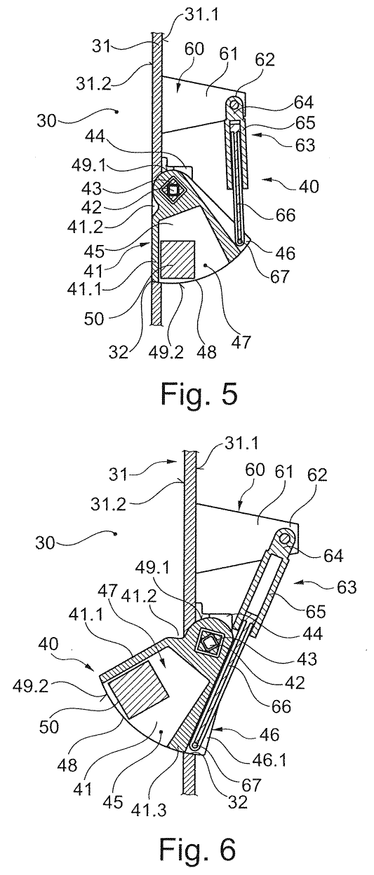

The support 40 has bearing attachments 42 on opposite ends, preferably in the area of the walls 45. The two bearing attachments 42 form a joint swivel axis. The bearing attachments 42 are each swivel mounted in bearing mounts 43 of a holder 44. The mounting 40 can thus be swiveled between a park position shown in FIGS. 4 and 5 and the detection position shown in FIG. 6.

An actuator 63 is used to move the mounting 40. The actuator 63 is preferably designed as a drive, in particular as a linear drive, particularly preferably as a piston-cylinder unit. The actuator 63 has a cylinder 65, in which a piston is movably arranged. The piston is connected to a piston rod 66, which is guided out of the cylinder 65. The piston rod 66 has an adjusting piece 67. This adjusting piece 67 is used to couple the piston rod 66 to the housing 41 in a swiveling manner.

The cylinder 65 has a bearing attachment 64. This bearing attachment 64 is attached to a holding device 60 in a swiveling manner. The holding device 60 may also be referred to as a holder 60 or as a bracket 60. As illustrated in drawings 4 to 6, preferably the holding device 60 may have two spacers 61 arranged spaced apart from each other. Preferably, the two spacers 61 are attached to the outer face 31.1 of the crushing chamber boundary 31. Facing away from the inner face 31.1, the spacers 61 have support parts 62. The bearing attachment 64 of the cylinder 65 is attached to the support parts 62. Preferably, the bearing attachment 64 is held in the area between the two spacers 61 in a swiveling manner. The bearing attachment and its swivel bearing is spaced apart from the outer face 31.1 of the crushing chamber boundary 31.

Preferably, the mounting 40 has a coupling element 46 to which the adjusting piece 67 of the actuator 63 is attached in a swiveling manner. The coupling element 46 can have a coupling-element mount 46.1. For a space-saving design, the coupling-element mount 46.1 is arranged and designed such that in the detection position (see FIG. 6) the piston rod 66 is accommodated in the coupling mount 46.1, at least sectionally. For this purpose, it is preferable that the coupling-element mount 46.1 is formed by a groove that is machined into the mounting 40 (see FIG. 4).

FIGS. 5 and 6 also illustrate that the housing 41 has a limiting element 41.3 on its end opposite from the bearing attachments 42. This limiting element 41.3 forms a contour area 49.2 in the area of the opening 48, which contour area preferably follows the shape of a circular arc, at least sectionally, in the sectional view through the swivel axis formed by the bearing attachments 42.

Additionally or alternatively, the housing 41 may form a contour area 49.1 opposite from the opening 48, which contour area preferably follows the shape of a circular arc, at least sectionally, in the section through the swivel axis formed by the bearing attachments 42.

The contour area 49.1 is opposite from a horizontal edge section of the inspection opening 32, as illustrated in FIG. 6. Preferably, this horizontal edge section of the inspection opening 32 may have a contour that follows the circular arc-shaped contour of the contour section 49.1. Preferably, the edge section and the contour area 49.1 have a circular arc shape, as illustrated in FIGS. 5 and 6. A narrow gap area is formed between the contour area 49.1 and the edge section to form a dust seal at the upper horizontal edge of the mounting 40.

The contour area 49.2 is opposite from a horizontal edge section of the inspection opening 32 in the area of the opening 48 of the housing 41. Preferably, this horizontal edge section of the inspection opening 32 has a contour that follows the circular arc-shaped contour of the contour section 49.2. Preferably, this horizontal edge section and the contour area 49.2 have a circular arc shape, as illustrated in the figures. A narrow gap area is formed between the contour area 49.2 and the horizontal edge section to form a seal at the lower horizontal edge of the mounting 40.

For a simple design, preferably provision is made for the contour areas 49.1, 49.2 to each form partial cylindrical surfaces. These two partial cylinder surfaces each have a cylinder axis that is aligned with the swivel axis of the bearing attachments 42. Thus, the two contour areas 49.1, 49.2 are guided precisely past the assigned edge sections of the inspection opening 32, wherein a tight seal is maintained.

In the detection position (FIG. 6) and/or in the park position (FIG. 5), the contour area 49.1 and/or the contour area 49.2 secure the tight seal between the inner face 31.2 and the outer face 31.1 of the crushing chamber boundary 31 through the inspection opening 32. Preferably, when the mounting 40 is moved from the detection position to the park position, the contour areas 49.1 and/or 49.2 are guided past the assigned edge section of the inspection opening such that the tight seal between the inner face 31.2 and the outer face 31.2 is maintained at least in a partial range of the positioning motion.

FIGS. 5 and 6 also illustrate that the mounting 40 has a groove-shaped recess 41.2 in the area of the swivel axis. FIG. 6 illustrates that in the detection position, the upper horizontal edge section of the inspection opening 32 engages at least sectionally with this recess 41.2 to be able to implement an enlarged swivel angle range of the mounting 40 in a simple manner.

FIG. 5 shows that the mounting 40 can comprise a closing arrangement 41.1. This closing arrangement 41.1 is preferably part of the mounting 40. However, it is also conceivable that the closing arrangement 41 is designed as a separate component that is connected to the mounting 40. It is also conceivable that the closing arrangement 41.1 forms a separate component that is not connected to the mounting 40.

The closing arrangement 41.1 is arranged and designed to close the inspection opening 31 at least sectionally when the detection device 50 is in the park position.

As illustrated in FIG. 5, it is preferable for the closing arrangement 41.1 to be flush with the inner face 31.2 in the park position.

FIG. 5 also illustrates that preferably the closing arrangement 41.1 may be a part of the housing 41, which delimits the mount 47.

During normal crushing operation of the material processing plant 1, the detection device 50 is in the park position shown in FIGS. 3-5. In this park position, the closing arrangement 41.1 closes the inspection opening 32. If at least one comminution tool 11.2 is to be checked, the actuator 63 is actuated. Then, the piston rod 66 moves relative to the cylinder 65 such that the piston rod 66 is extended. As a result of this positioning motion, the mounting 40 is swiveled about the swivel axis formed by the bearing attachments 42. Preferably, the contour areas 49.1 and/or 49.2 slide past the assigned horizontal edge sections of the inspection opening 32. As soon as the mounting 40 has been moved into the detection position, the detection device 50 can detect the state of the comminution tool 11.2. Preferably, the detection device 50 is designed as an optical detection device. In the detection position, a visual connection, preferably a straight line, is formed between the comminution tool 11.2 and the detection device 50.

FIG. 6 illustrates that it is preferable for the opening 48 of the housing 41 to face downwards in the detection position. This prevents objects falling inside the crushing chamber from hitting the detection device 50 and damaging it.

Preferably, the detection device 50 is covered at the top by a cover against the direction of gravity. This cover can preferably be formed by the closing arrangement 41.1.

Once the detection of the wear condition of the cutting tool 11.2 has been completed, the actuator 63 can be used to return the mounting 40 into the park position as shown in FIG. 5.

FIG. 5 illustrates that it is preferable in the park position for the opening 48 to be accessible from the outer face 31.1. Preferably, the opening 48 is directed downwards in the direction of gravity in the park position, such that no dirt can fall through the opening 48 into the mount 47.

FIG. 4 illustrates that the outer faces of the walls 45 of the mounting 40 are guided past the vertical edge sections of the inspection opening 32 during the movement of the mounting 40 between the detection position and the park position. Preferably, a narrow gap area is formed between the outer faces of the walls 45 and the vertical edge sections of the inspection opening 32, which is sufficiently small to prevent dust from reaching the area behind the outer face 31.1 from the inner face 31.2 during the crushing operation. This makes for a dust-tight seal.

It is also conceivable for the inspection opening 32 to be circumferentially sealed by means of sealing elements, at least sectionally, to prevent dust from entering.

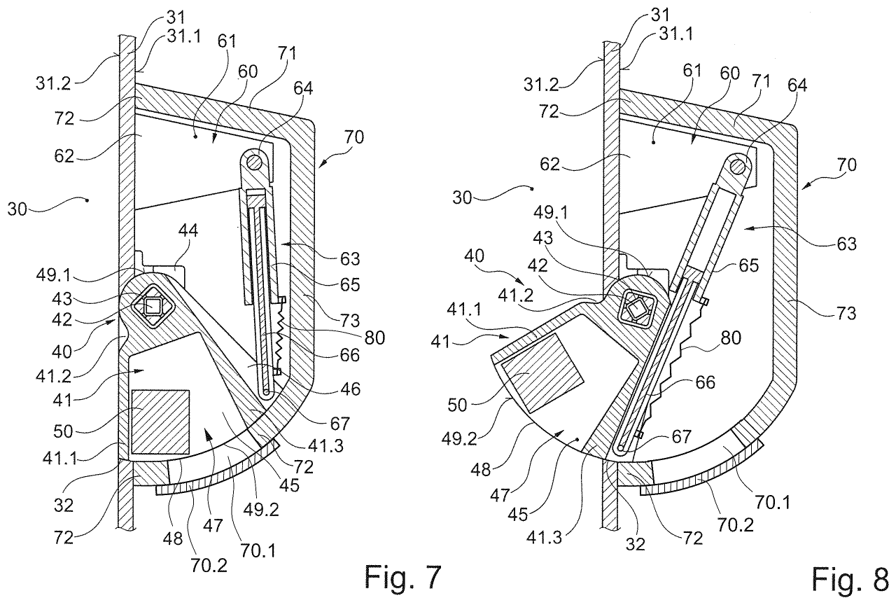

FIGS. 7 and 8 show a further development of the monitoring device of FIGS. 2-6. Identical components are marked by the same reference numerals, which is why reference can be made to the above explanations to avoid repetition.

In addition to the embodiment described above, the monitoring device of FIGS. 7 and 8 has a cover 70. The cover 70 is used to cover the detection device 50, the holding device 60 and/or the mounting 40 in the area of the outer face 31.1, at least sectionally, when the detection device 50 is in the park position.

As the illustrations show, the cover 70 has a circumferential wall 71, which is attached to the outer face 31.1 by means of a fastening section 72. The cover 70 has a cover section 73, which is held at a distance from the outer face 31.1 by means of the wall 71. In that way, the detection device 50 can be positioned in the park position between the deck section 73 and the outer face 31.1. This is shown in FIG. 7.

Preferably, as schematically shown in FIGS. 7 and 8, the cover 70 has a maintenance opening 70.1, through which the opening 48 and thus the detection device 50 is accessible for maintenance purposes. Preferably, this opening of the cover 70 can be closed by a maintenance closure 70.2.

As is further schematically shown in FIGS. 7 and 8, in the detection position of FIG. 8 provision may also be made for a return spring 80 having a pretensioning force, which acts in the direction of the park position, to act directly or indirectly on the sensor 50 to generate or support an adjustment movement of the sensor 50 in the direction of the park position of FIG. 7. As a result, the sensor 50, in particular the mounting 41, is held in the park position or brought into the park position when the actuator 63 is deactivated. This increases operational safety.

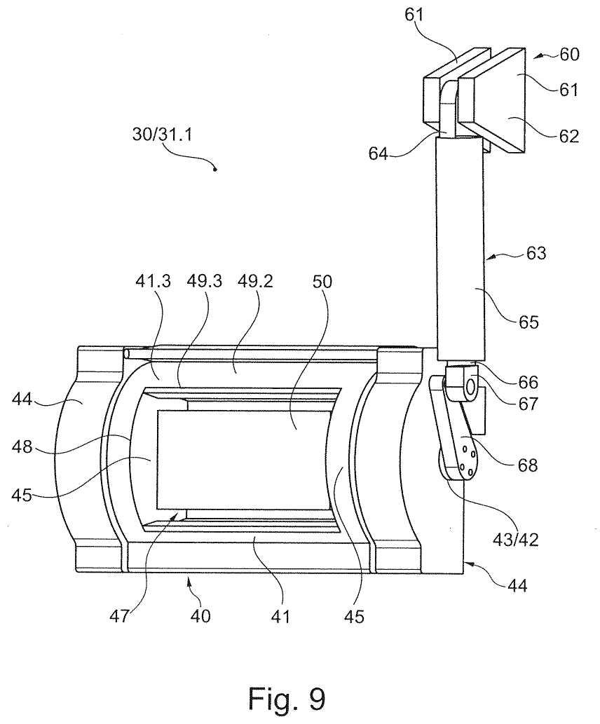

FIG. 9 shows a further design variant of the disclosure. Identical components are marked by the same reference numerals, which is why reference can be made to the above explanations to avoid repetition.

As this illustration shows, the actuator 63 of the holding device 60 is coupled to the mounting 40 by means of a transmission, which in this case is designed as a simple swivel lever transmission. The transmission therefore has a lever 68 that can be driven by the actuator 63. The lever 68 is directly or indirectly connected for co-rotation to a bearing attachment 42 of the mounting 40. This allows the mounting 40 to be swiveled about a swivel axis when the lever 68 is swiveled.

FIG. 9 illustrates that the mounting 40 again has a housing 41 having an opening 48. Thus, the mounting 40 again has essentially the same design as the mounting 40 according to the preceding exemplary embodiments of FIGS. 2-8. Reference is made to the statements above.

The mounting 40 is arranged between two holders 40 and is coupled to the holders 44 via the bearing attachments 42 in a swiveling manner.

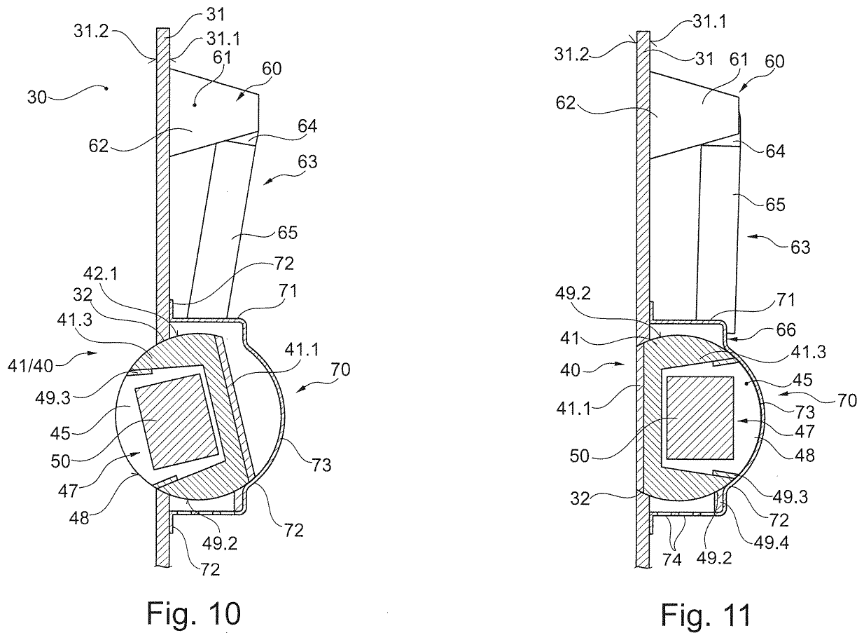

FIG. 10 illustrates the detection position of the detection device 50 and FIG. 11 the park position. FIG. 10 shows that the mounting 40 again has contour areas 49.1, 49.2 on opposite ends. The contour areas 49.1, 49.2 can merge continuously into each other, as FIG. 10 shows. In particular, the contour areas 49.1, 49.2 can form a common circular arc section, at least sectionally (FIG. 10).

FIGS. 10 and 11 also show that the closing arrangement 41.1 can be formed by a separate component, which is applied to the mounting 40 and which closes the inspection opening 32 in the park position. The closing arrangement 41.1 may also be referred to as an inspection closure 41.1

FIG. 11 shows that a sealing arrangement having a sealing element 49.3 is effective between the mounting 40 and the cover 70. The sealing element 49.3 is arranged in the area of the opening 48 of the housing 41. The sealing element 49.3 is arranged and designed to seal the opening at least sectionally in the park position in conjunction with the cover section 73 of the cover 70. This prevents contamination from entering the area of the mount 47.

According to FIG. 11, a wiper 49.4 may also act on at least one of the contour areas 49.1, 49.2 or on another area of the housing 41 during the movement of the housing 41 between the park position and the detection position. The wiper 49.4 is used to clean off impurities that adhere to the outside of the housing 41 during this adjustment movement.

FIG. 11 illustrates, for instance, that such a wiper 49.4 can be held in the area of the cover 70. Cleaned impurities can then preferably be collected in the area of the cover 70 and discharged in an orderly manner via openings 74 of the housing.

In the explanations above, the mode of operation of the disclosure was explained with reference to the detection of the wear condition of the comminution tool 11.2. However, the disclosure is not limited to this; rather, the wear condition of any other wear part in the crushing chamber may additionally or alternatively be detected by the detection device 50.

1-16. (canceled)

17. A crushing device for crushing mineral material, comprising:
at least one crushing chamber boundary delimiting a crushing chamber, the at least one crushing chamber boundary including an inner face facing the crushing chamber and an outer face facing away from the crushing chamber, the crushing chamber boundary including an inspection opening;
a comminution device received in the crushing chamber, the comminution device including at least one comminution tool;
a sensor configured to determine a state of wear of at least one wear part in the crushing chamber;
a mounting configured to hold the sensor; and
an actuator configured to move the sensor at least partially through the inspection opening between a park position wherein the sensor is at least partially outside of the crushing chamber and a detection position wherein the sensor is at least partially inside of the crushing chamber.

18. The crushing device of claim 17, wherein:
the comminution device is received in the crushing chamber rotatably or in a swiveling manner;
the comminution tool is a crushing tool; and
the wear part is the crushing tool.

19. The crushing device of claim 17, wherein:
the actuator is outside of the crushing chamber at least in the park position of the sensor.

20. The crushing device of claim 17, wherein:
the actuator is operably associated with the mounting such that the actuator can move the mounting between a park position and a detection position of the mounting corresponding to the park position and the detection position of the sensor; and
the sensor is moved at least partially translationally or at least partially along an arcuate path when the sensor is moved between the park position and the detection position.

21. The crushing device of claim 20, wherein:
the mounting is swiveled by more than 60° between the park position and the detection position.

22. The crushing device of claim 20, wherein:
the mounting includes a housing in which the sensor is received, the housing including a light-transmission area establishing a straight line of sight between the sensor at the at least one wear part when the mounting is in the detection position.

23. The crushing device of claim 17, further comprising:
a sealing arrangement configured to close the inspection opening at least partially in a dust-tight manner in the park position and/or in the detection position.

24. The crushing device of claim 23, wherein:
as a part of the sealing arrangement the mounting includes sealing sections which in the park position face edge sections of the inspection opening in a sealing manner.

25. The crushing device of claim 23, wherein:
as a part of the sealing arrangement the mounting includes a limiting element which in the detection position faces edge sections of the inspection opening in a sealing manner.

26. The crushing device of claim 17, wherein:
the mounting swivels about a swivel axis to move the sensor between the park position and the detection position;
the mounting includes first and second sealing sections arranged on opposite ends of the mounting and extending parallel to the swivel axis, the first sealing section having a first outer contour following a shape of a first partial cylinder having a first cylinder axis extending parallel to the swivel axis, and the second sealing section having a second outer contour following a shape of a second partial cylinder having a second cylinder axis extending parallel to the swivel axis, wherein the first and second cylinder axes and the swivel axis are co-axial;
the inspection opening includes first and second edge sections having first and second contours following the shapes of the first and second partial cylinders, respectively; and
the sealing sections of the mounting face the edge sections of the inspection opening in the park position and/or the detection position to at least partially seal the inspection opening.

27. The crushing device of claim 17, wherein:
the actuator is a linear actuator including a cylinder and a piston guided in the cylinder, the piston being coupled to a piston rod, and the actuator is coupled directly or indirectly to the sensor in a swiveling manner.

28. The crushing device of claim 17, further comprising:
a bracket attached to the outer face of the crushing chamber boundary;
wherein the actuator includes a bearing attachment mounted on the bracket in a swiveling manner so that the bearing attachment is held by the bracket spaced apart from the outer face of the crushing chamber boundary.

29. The crushing device of claim 17, further comprising:
a cover mounted on the outer face of the crushing chamber boundary and including a cover section spaced a distance from the outer face of the crushing chamber boundary;
wherein the mounting is covered by the cover section of the cover when the sensor is in the park position.

30. The crushing device of claim 29, wherein:
the sensor is received in a mount space of the mounting, which mount space is accessible through an opening of the mounting; and
the crushing device further includes a seal between the cover and the mount space to at least partially seal the mount space.

31. The crushing device of claim 29, wherein:
the cover includes a maintenance opening through which the sensor may be accessed in the park position; and
the cover includes a maintenance closure configured to open and close the maintenance opening.

32. The crushing device of claim 17, further comprising:
an inspection closure configured to close the inspection opening when the inspection closure is in a closed position, wherein the inspection closure in the closed position is arranged between the crushing chamber and the sensor, wherein a surface of the inspection closure facing the crushing chamber has a wear resistance equal to or greater than a wear resistance of the crushing chamber boundary.

33. The crushing device of claim 17, further comprising:
a return spring acting directly or indirectly on the sensor in a direction of the park position to generate or support a movement of the sensor in the direction of the park position.

34. The crushing device of claim 17, further comprising:
a wiper; wherein
the mounting includes a contour area which is guided past the wiper during a movement between the detection position and the park position.
